(19) United States
(12) Patent Application Publication
(10) Pub. No.: US 2023/0384422 A1
(43) Pub. Date: Nov. 30, 2023

(54) METHOD FOR ANALYZING SHAPE OF OBJECT AND DEVICE FOR TRACKING OBJECT WITH LIDAR

(71) Applicants: Hyundai Motor Company, Seoul (KR); Kia Corporation, Seoul (KR)

(72) Inventor: Mi Rim Noh, Jeonju (KR)

(21) Appl. No.: 17/900,198

(22) Filed: Aug. 31, 2022

(30) Foreign Application Priority Data
May 27, 2022 (KR) 10-2022-0065238

(51) Int. Cl. G01S 7/48; G06K 9/62; G01S 17/931

(52) U.S. Cl. CPC G01S 7/4802; G06K 9/6218; G01S 17/931

(57) ABSTRACT

The present disclosure relates to a method of analyzing a shape of an object and a device for tracking an object with LiDAR. A method for analyzing a shape of an object by use of LiDAR, according to an embodiment of the present disclosure, comprises obtaining a plurality of layers of LiDAR points for the object by use of the LiDAR, determining a shape flag for each of the layers by use of at least a part of LiDAR points thereon according to a plurality of predetermined shape types, calculating a confidence score for the shape flag determined for each of the layers by use of the at least part of LiDAR points; and determining a shape flag of the object by use of the shape flags determined for the plurality of layers and the confidence scores.

### CROSS-REFERENCE TO RELATED APPLICATION

The present application claims priority under 35 U.S.C. § 119(a) to Korean Patent Application No. 10-2022-0065238, filed on May 27, 2022, the entire contents of which is incorporated herein for all purposes by this reference.

### BACKGROUND OF THE PRESENT DISCLOSURE

### Field of the Present Disclosure

The present disclosure relates to a method of analyzing a shape of an object and a device for tracking an object with LiDAR.

### Discussion of Related Art

Information about a target vehicle may be acquired using a Light Detection and Ranging (LiDAR) sensor(s), and an autonomous driving function of a vehicle (hereinafter referred to as a “host vehicle”) equipped with LiDAR may be assisted using the acquired information. However, when information about a target vehicle, which may be acquired by LiDAR, may be incorrect, the reliability of the host vehicle for autonomous driving may be deteriorated. Therefore, research for solving this problem may be underway.

In particular, when multiple-layered point data may be obtained for an object through LiDAR and the heading of the object may be determined from a layer selected through analyzing LiDAR points of each layer, if the selection of the layer is not appropriate, the reliability may also be greatly deteriorated.

The information included in this Background of the present disclosure section is only for enhancement of understanding of the general background of the present disclosure and may not be taken as an acknowledgement or any form of suggestion that this information forms the prior art already known to a person skilled in the art.

### BRIEF SUMMARY

Various embodiments of the present disclosure may be directed to providing a method for analyzing a shape of an object and a device for tracking an object using LiDAR, which may be capable of analyzing a shape of a moving object especially for determining the heading.

Technical embodiments of the present disclosure may not be limited to the foregoing embodiments, and other technical embodiments will be apparent to a person having ordinary skills in the art from the description.

A method for analyzing a shape of an object by use of LiDAR, according to an embodiment of the present disclosure, comprises obtaining a plurality of layers of LiDAR points for the object by use of the LiDAR, determining a shape flag for each of the layers by use of at least a part of LiDAR points thereon according to a plurality of predetermined shape types, calculating a confidence score for the shape flag determined for each of the layers by use of the at least part of LiDAR points; and determining a shape flag of the object by use of the shape flags determined for the plurality of layers and the confidence scores.

In at least one embodiment, the confidence score may be calculated differently according to the predetermined shape type which the determined shape flag belongs to.

In at least one embodiment, the at least part of LiDAR points includes outer points which include a first end point, a second end point, and a break point, and the confidence score may be calculated by use of the outer points.

In at least one embodiment, the plurality of predetermined shape types include a L-shape and a I-shape, and the shape flag for each of the layers may be determined by a length and/or a width of a smallest rectangular shape box encompassing the outer points, and the confidence score includes a first score for the L-shape and a second score for the I-shape, the second score calculated differently from the first score.

In at least one embodiment, the first score may be calculated by at least one of a first L-parameter which may be calculated from distance variances of the associated outer points to a first line segment and a second line segment, respectively, the first line segment formed by connecting the first end point and the break point and the second line segment formed by connecting the break point and the second end point, a second L-parameter which may be calculated according to whether the associated outer points may be located at a host-vehicle side with respect to the first and second line segments, respectively, a third L-parameter which may be calculated from angles between two neighboring segments, each segment formed by connecting two neighboring points of the outer points, a fourth L-parameter which may be calculated according to whether there exists at least one of the outer points in each inner side division area other than either outer side among division areas which may be formed by dividing each of the line segments with 3 or more perpendicular lines, and a fifth L-parameter which may be calculated according to a proportion of at least one of length, width, and area between the shape box and a cluster box which may be defined by the whole LiDAR points of the object.

In at least one embodiment, the first score may be calculated by summing the L-parameters multiplied by weights, respectively.

In at least one embodiment, the weight for the fifth L-parameter may be greatest, the weight for the first of fourth L-parameter next greatest, and the weight for the second or third L-parameter smallest.

In at least one embodiment, the second score may be calculated by at least one of a first I-parameter which may be calculated from a distance variance of the associated outer points to a longer one of a first line segment and a second line segment, the first line segment formed by connecting the first end point and the break point and the second line segment formed by connecting the break point and the second end point, and a second I-parameter which may be calculated from angles between two neighboring segments associated to the second line segment, each segment formed by connecting tow neighboring points of the outer points.

In at least one embodiment, the second score may be calculated by summing the I-parameters multiplied by weights, respectively.

In at least one embodiment, the weight for the first I-parameter may be greater than the one for the second I-parameter.

In at least one embodiment, the determination of the shape flag of the object may be according to a predetermined priority order for the plurality of predetermined shape types, and may be finally made with the scores taken into consideration.

In at least one embodiment, the plurality of predetermined shape types include a L-shape and a I-shape, and the L-shape may be prior to the I-shape according to the predetermined priority order.

In at least one embodiment, in case where at least one L-shape flag may be included in the plurality of layers, if at least one of a first condition of whether a number of I-shape flags may be greater that a number of L-shape flags for the plurality of layers and a second condition that a greatest score among L-shape flag scores may be below a first predetermined score and a greatest score among I-shape flag scores may be equal to or over a second predetermined score may be satisfied, then the shape flag of the object may be determined as the I-shape.

In at least one embodiment, if there may be no L-shape flag in the plurality of layers and at least one I-shape flag may be included, then the shape flag of the object may be determined as the I-shape.

In at least one embodiment, the plurality of predetermined shape types further include a sL-shape, and the I-shape may be prior to the sL-shape according to the predetermined priority order.

In at least one embodiment, in case where there exists neither I-shape nor L-shape in the plurality of layers and at least one sL-shape flag may be included, if a greatest score among sL-shape flag scores may be equal to or over a third predetermined score, then the shape flag of the object may be determined as the sL-shape.

In at least one embodiment, a heading of the object may be determined using the LiDAR points on a layer whose shape flag may be determined as the shape flag of the object.

An object tracking device according to an embodiment of the present disclosure comprises LiDAR configure to obtain first to M^{th} (M is an integer of 2 or greater) layers of LiDAR points for objects including a target object, a clustering unit configured to group neighboring and similar points of the LiDAR points into clusters, and a shape analysis unit configured to analyze a shape of the target object based on a clustered LiDAR points, wherein the shape analysis unit comprises a layer shape determination unit configured to determine a shape flag for each of the first to M^{th} layers by use of at least a part of LiDAR points thereon according to a plurality of predetermined shape types, and calculate a confidence score for the shape flag determined for each layer by use of the at least part of LiDAR points, and a target shape determination unit configured to determine a shape flag of the object by use of the shape flags determined for the layers and the confidence scores.

According to an embodiment of the present disclosure, a shape of a target object and the heading may be obtained more precisely by use of LiDAR.

Exemplary embodiments described herein may include a vehicle comprising the object tracking device as described herein.

And also, the performance and reliability of an autonomous vehicle may be enhanced.

The methods and devices of the present disclosure have other features and advantages which will be apparent from or may be set forth in more detail in the accompanying drawings, which may be incorporated herein, and the following Detailed Description, which together serve to explain certain principles of the present disclosure.

### BRIEF DESCRIPTION OF THE DRAWINGS

FIG. 1 is a schematic block diagram of an object-tracking device using LiDAR according to an embodiment.

FIG. 2 is a flowchart of a method of analyzing the shape of an object using LiDAR according to an embodiment.

FIG. 3 is a block diagram of an embodiment of the shape analysis unit shown in FIG. 1.

FIG. 4 is a flowchart of an embodiment of step 210 shown in FIG. 2.

FIG. 5 is a diagram exemplarily showing LiDAR points included in the m^{th} layer.

FIG. 6 is a flowchart of an embodiment of step 316 shown in FIG. 4.

FIG. 7 is a flowchart of an embodiment of step 318 shown in FIG. 4.

FIGS. 8A and 8B are exemplary diagrams for helping understanding step 318A shown in FIG. 7.

FIG. 9 is a flowchart of an embodiment of step 320 shown in FIG. 4.

FIG. 10 is a diagram for helping understanding the embodiment shown in FIG. 9.

FIG. 11 is a flowchart of another embodiment of step 320 shown in FIG. 4.

FIG. 12 is a diagram for helping understanding the embodiment shown in FIG. 11.

FIG. 13 is a flowchart of an embodiment of step 322 shown in FIG. 4.

FIG. 14 is a diagram for helping understanding step 602 shown in FIG. 13.

FIGS. 15(a) and 15(b) are diagrams for helping understanding step 604 shown in FIG. 13.

FIG. 16 is a diagram for helping understanding step 606 shown in FIG. 13.

FIG. 17 is a flowchart of an embodiment of step 220 shown in FIG. 2.

FIG. 18 shows various types of target vehicles on the basis of a host vehicle.

FIG. 19 represents results from a method for analyzing shapes of objects according to an embodiment of the present disclosure and a comparison method.

FIG. 20 represents another results from a method for analyzing shapes of objects according to an embodiment of the present disclosure and a comparison method.

It may be understood that the appended drawings may not be necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Reference will now be made in detail to various embodiments of the present disclosure(s), examples of which may be illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

In case where identical elements may be included in various embodiments, they will be given the same reference numerals, and redundant description thereof will be omitted. In the following description, the terms “module” and “unit” for referring to elements may be assigned and used interchangeably in consideration of convenience of explanation, and thus, the terms per se do not necessarily have different meanings or functions.

Furthermore, in describing the exemplary embodiments, when it may be determined that a detailed description of related publicly known technology may obscure the gist of the exemplary embodiments, the detailed description thereof will be omitted. The accompanying drawings may be used to help easily explain various technical features and it should be understood that the exemplary embodiments presented herein may not be limited by the accompanying drawings. Accordingly, the present disclosure should be construed to extend to any alterations, equivalents and substitutes in addition to those which may be particularly set out in the accompanying drawings.

Although terms including ordinal numbers, such as “first”, “second”, etc., may be used herein to describe various elements, the elements may not be limited by these terms. These terms may be generally only used to distinguish one element from another.

When an element may be referred to as being “coupled” or “connected” to another element, the element may be directly coupled or connected to the other element. However, it should be understood that another element may be present therebetween. In contrast, when an element may be referred to as being “directly coupled” or “directly connected” to another element, it should be understood that there may be no other elements therebetween.

A singular expression includes the plural form unless the context clearly dictates otherwise.

In the exemplary embodiment, it should be understood that a term such as “include” or “have” may be intended to designate that the features, numbers, steps, operations, elements, parts, or combinations thereof described in the specification may be present, and does not preclude the possibility of addition or presence of one or more other features, numbers, steps, operations, elements, parts, or combinations thereof.

Unless otherwise defined, all terms including technical and scientific ones used herein have the same meanings as those commonly understood by one of ordinary skill in the art to which this disclosure belongs. It will be further understood that terms, such as those defined in commonly used dictionaries, should be interpreted as having meanings consistent with their meanings in the context of the relevant art and the present disclosure, and may not be to be interpreted in an idealized or overly formal sense unless expressly so defined herein.

Furthermore, the term “unit” or “control unit” included in the names of a hybrid control unit (HCU), a motor control unit (MCU), etc. may be merely a widely used term for naming a controller configured for controlling a specific vehicle function, and does not mean a generic functional unit. For example, each controller may include a communication device that communicates with another controller or a sensor to control a function assigned thereto, a memory that stores an operating system, a logic command, input/output information, etc., and one or more processors that perform determination, calculation, decision, etc. necessary for controlling a function assigned thereto.

Hereinafter, a method 200 of analyzing a shape of an object and a device 100 for tracking an object by use of a LiDAR sensor according to embodiments will be described with reference to the accompanying drawings. The method 200 of analyzing a shape of an object and the device 100 for tracking an object using a LiDAR sensor will be described using the Cartesian coordinate system (x-axis, y-axis, z-axis) for convenience of description, but may also be described using other coordinate systems. In the Cartesian coordinate system, the x-axis, the y-axis, and the z-axis may be perpendicular to each other, but the embodiments may not be limited thereto. That is, the x-axis, the y-axis, and the z-axis may intersect each other obliquely.

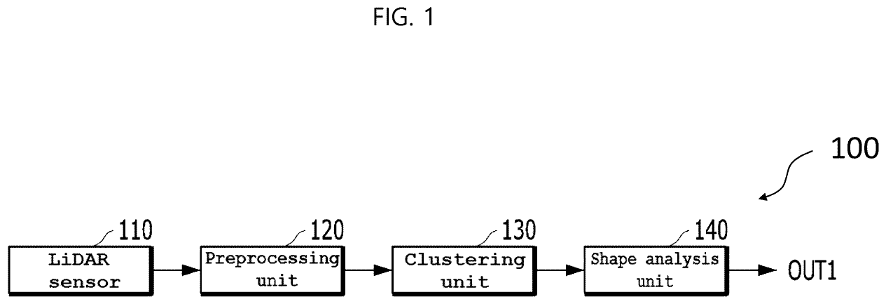

FIG. 1 is a schematic block diagram of an object-tracking device 100 using a LiDAR sensor according to an exemplary embodiment.

The object-tracking device 100 shown in FIG. 1 may include a LiDAR sensor 110, a preprocessing unit 120, a clustering unit 130, and a shape analysis unit 140.

The LiDAR sensor 110 may be configured to acquire a point cloud related to a target object, and may be configured to output the acquired point cloud to the preprocessing unit 120 as LiDAR data. In this embodiment, the LiDAR sensor 110 may be suitable to obtain a plurality of layers of LiDAR data for the object, each layer responsible for LiDAR point data of the object at its corresponding position in a vertical axis.

The preprocessing unit 120 may be configured to preprocess the LiDAR data. To this end, the preprocessing unit 120 may be configured to perform calibration to match the coordinates between the LiDAR sensor 110 and a vehicle equipped with the LiDAR sensor 110 (hereinafter referred to as a “host vehicle”). That is, the preprocessing unit 120 may convert the LiDAR data into data suitable for the reference coordinate system in consideration of the positional angle at which the LiDAR sensor 110 may be mounted to the host vehicle. In addition, the preprocessing unit 120 may perform filtering to remove points having low intensity or reflectance using intensity or confidence information of the LiDAR data. In addition, the preprocessing unit 120 may remove data reflected from the host vehicle. That is, since there may be a region that may be shielded by the body of the host vehicle depending on the mounting position and the field of view of the LiDAR sensor 110, the preprocessing unit 120 may remove data reflected from the body of the host vehicle using the reference coordinate system.

The clustering unit 130 may be configured to group the point cloud, which may be the LiDAR data composed of a plurality of points related to the object acquired using the LiDAR sensor 110, into meaningful units according to a predetermined criterion. That is, the clustering unit 130 may be configured to cluster the point cloud using the result of the preprocessing by the preprocessing unit 120, and may output the clustered LiDAR points to the shape analysis unit 140.

The shape analysis unit 140 may be configured to analyze the shape of a target object using the clustered LiDAR points of the point cloud, and may output the result of the analysis through an output terminal OUT1.

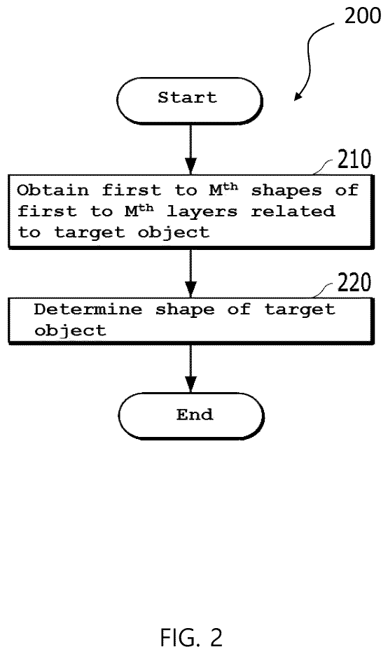

FIG. 2 is a flowchart of a method 200 of analyzing the shape of an object using a LiDAR sensor according to an embodiment.

The shape analysis unit 140 shown in FIG. 1 may be configured to perform the shape analysis method 200 shown in FIG. 2, but the embodiment may not be limited thereto. That is, according to another embodiment, the shape analysis method 200 shown in FIG. 2 may be performed by an object-tracking device configured differently from the object-tracking device 100 shown in FIG. 1. That is, the method 200 shown in FIG. 2 may not be limited to any specific type of operation performed by the LiDAR sensor 110, the presence or absence of the preprocessing unit 110, any specific type of preprocessing performed by the preprocessing unit 110, or any specific type of clustering performed by the clustering unit 130 in the device shown in FIG. 1.

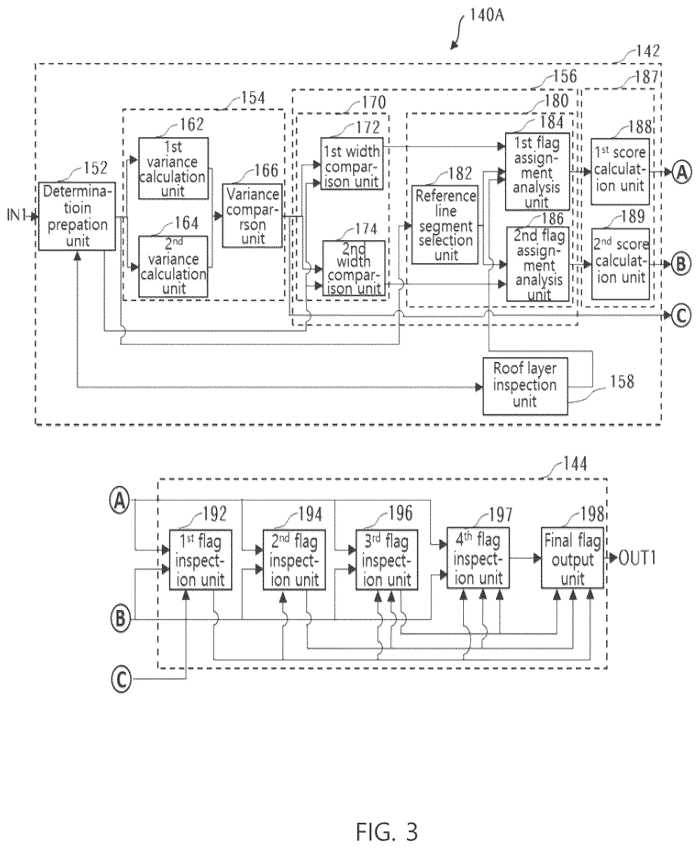

FIG. 3 is a block diagram of an embodiment 140A of the shape analysis unit 140 shown in FIG. 1.

Hereinafter, for better understanding, the object shape analysis method 200 according to the embodiment will be described as being performed by the shape analysis unit 140A shown in FIG. 3, but the embodiment is not limited thereto. That is, according to another embodiment, the object shape analysis method 200 according to the embodiment may also be performed by a shape analysis unit configured differently from the shape analysis unit 140A shown in FIG. 3.

The shape analysis unit 140A shown in FIG. 3 may include a layer shape determination unit 142 and a target shape determination unit 144.

The layer shape determination unit 142 may be configured to receive the clustered LiDAR points from the clustering unit 130 through an input terminal IN1, may be configured to determine the first to M^{th} shapes of first to M^{th} layers related to a target object using the LiDAR points, and may be configured to output the determined shapes of the first to M^{th} layers to the target shape determination unit 144 (step 210). Here, “M” may be a positive integer of 2 or greater.

After step 210, the target shape determination unit 144 may finally determine the shape of the target object by analyzing the 1^{st} to M^{th} shapes according to a predetermined priority, and may output the determined shape of the target object through the output terminal OUT1 (step 220).

Hereinafter, embodiments of the object shape analysis method 200 shown in FIG. 2, the layer shape determination unit 142 shown in FIG. 3, and the target shape determination unit 144 shown in FIG. 3 will be described with reference to the accompanying drawings.

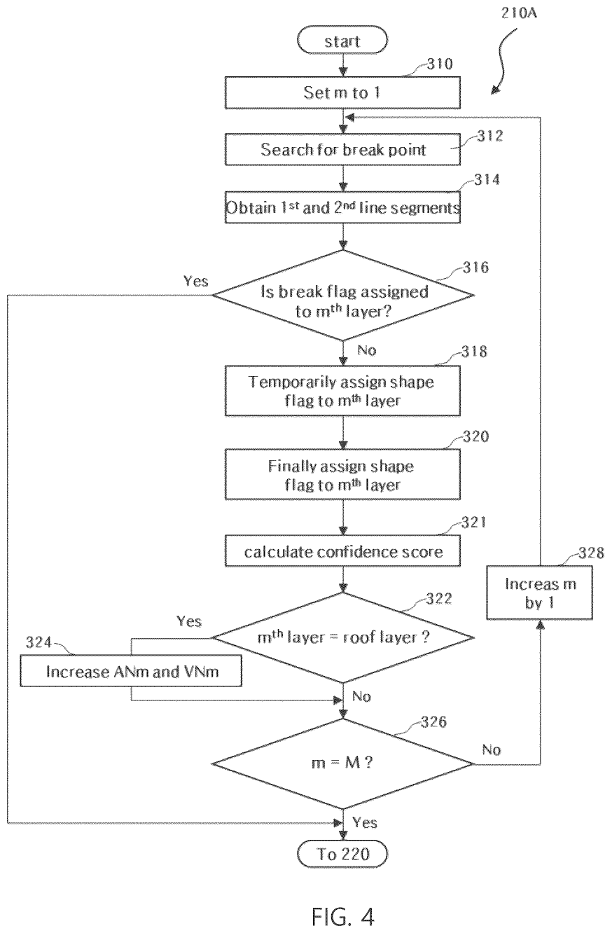

FIG. 4 is a flowchart of an embodiment 210A of step 210 shown in FIG. 2.

The layer shape determination unit 142 shown in FIG. 3 may perform the method 210A shown in FIG. 4. To this end, the layer shape determination unit 142 may include a determination preparation unit 152 and a flag assignment unit 156. In addition, the layer shape determination unit 142 may further include a moving object analysis unit 154. In addition, the layer shape determination unit 142 may further include a roof layer inspection unit 158.

The shape of each of the M layers, i.e. the first to M^{th} layers, related to one target object may be determined as follows.

First, “m” is set to 1 (step 310). Here, 1≤m≤M.

After step 310, among the LiDAR points included in the m^{th} layer, the break point that is located farthest from the line segment (or baseline) connecting the first end point and the second end point is searched for (step 312).

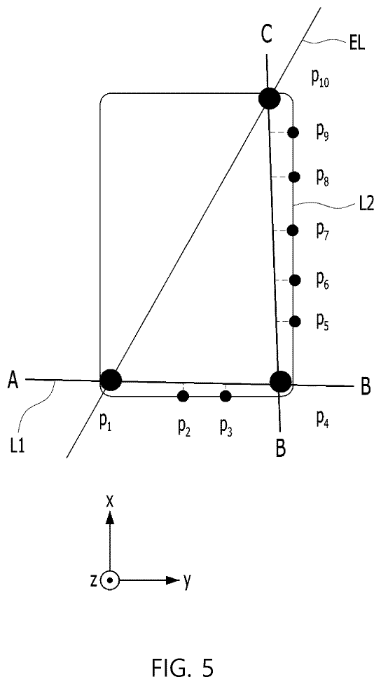

FIG. 5 is a diagram exemplarily showing the LiDAR points included in the m^{th} layer.

For better understanding, step 210A shown in FIG. 4 will be described with reference to FIG. 5, but is not limited thereto.

The LiDAR points related to one target object may be divided into M layers, i.e. the first to M^{th} layers, in a vertical direction (e.g. the z-axis direction).

After step 310, among the LiDAR points included in the m^{th} layer (e.g. p1 to p10 shown in FIG. 5), the break point B (p4) that is located farthest from the line segment EL connecting the first end point A (p1) and the second end point C (p10) is searched for (step 312).

Thereafter, a first line segment L1 connecting the first end point p1 and the break point p4 and a second line segment L2 connecting the second end point p10 and the break point p4 are generated (step 314).

Steps 310 to 314 described above may be performed by the determination preparation unit 152 shown in FIG. 3.

After step 314, the moving object analysis unit 154 may analyze the distribution pattern of the first and second LiDAR points in the m^{th} layer, and may determine whether to assign a break flag to the m^{th} layer as a shape flag using the result of the analysis (step 316).

Here, the first LiDAR points may be LiDAR points (e.g. p2 and p3) located near the first line segment L1, among the LiDAR points (e.g. p1 to p10 shown in FIG. 5). The second LiDAR points may be LiDAR points (e.g. p5 to p9 shown in FIG. 5) located near the second line segment L2, among the LiDAR points (e.g. p1 to p10 shown in FIG. 5).

The break flag may be a flag indicating that the possibility that the target object displayed through the LiDAR points included in the m^{th} layer is a moving object is low. That is, when the degree to which the LiDAR points are dispersed in the m^{th} layer is large, there is a possibility that the target object is a static object rather than a moving object. Therefore, it is possible to check whether the target object is a moving object or a static object using the variance of the LiDAR points.

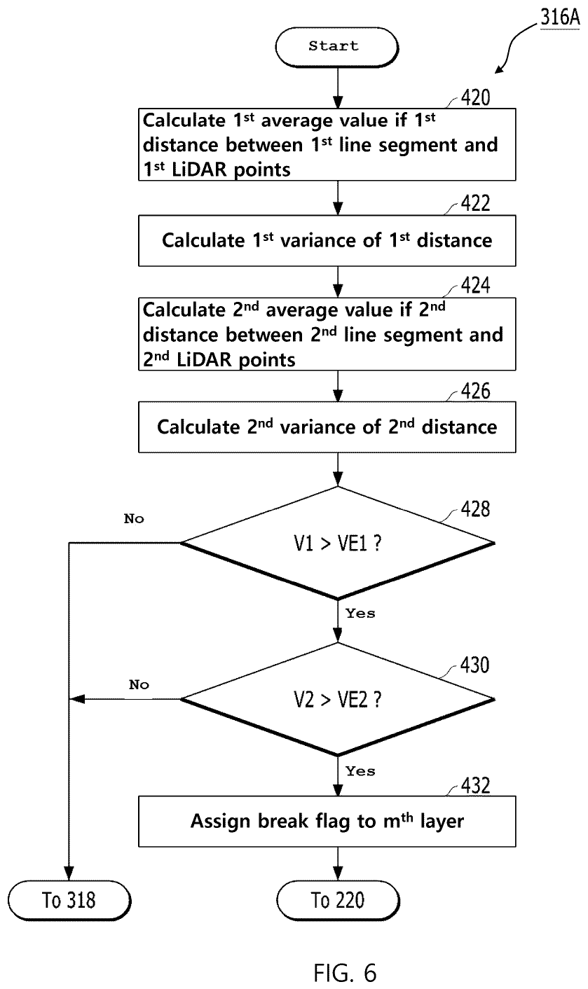

FIG. 6 is a flowchart of an embodiment 316A of step 316 shown in FIG. 4.

The moving object analysis unit 154 may perform step 316A shown in FIG. 6. To this end, the moving object analysis unit 154 may include, for example, a first variance calculation unit 162, a second variance calculation unit 164, and a variance comparison unit 166.

For example, referring to FIGS. 3 and 6, after step 314, the first variance calculation unit 162 calculates a first average value A1 of the first distances between the first line segment L1 and the first LiDAR points, as expressed using Equation 1 below (step 420).

$$A 1 = \frac{1}{n} {\sum }_{i = 1}^{n} xi \qquad [ Equation 1 ]$$

Here, “n” represents the total number of first LiDAR points included in the mth layer, and “xi” represents the first distances. Referring to FIG. 5, “xi” corresponds to the spacing distances between the respective first LiDAR points p2 and p3 and the first line segment L1 in the x-axis direction.

After step 420, the first variance calculation unit 162 calculates a first variance V1 of the first distances xi using the first average value A1 of the first distances xi, as expressed using Equation 2 below, and outputs the calculated first variance V1 to the variance comparison unit 166 (step 422).

$$V 1 = \frac{1}{n} {\sum }_{i = 1}^{n} {( xi - A 1 )}^{2} \qquad [ Equation 2 ]$$

After step 422, the second variance calculation unit 164 calculates a second average value A2 of the second distances yi between the second line segment L2 and the second LiDAR points, as expressed using Equation 3 below (step 424).

$$A 2 = \frac{1}{q} {\sum }_{i = 1}^{q} yi \qquad [ Equation 3 ]$$

Here, “q” represents the total number of second LiDAR points included in the m^{th} layer, and “yi” represents the second distances. Referring to FIG. 5, “yi” corresponds to the spacing distances between the respective second LiDAR points p5 to p9 and the second line segment L2 in the y-axis direction.

After step 424, the second variance calculation unit 164 calculates a second variance V2 of the second distances yi using the second average value A2 of the second distances yi, as expressed using Equation 4 below, and outputs the calculated second variance V2 to the variance comparison unit 166 (step 426).

$$V 2 = \frac{1}{q} {\sum }_{i = 1}^{q} {( yi - A 2 )}^{2} \qquad [ Equation 4 ]$$

After step 426, the variance comparison unit 166 determines whether the first variance V1 is greater than a first variance threshold value VE1 (step 428). If the first variance V1 is greater than the first variance threshold value VE1, the variance comparison unit 166 determines whether the second variance V2 is greater than a second variance threshold value VE2 (step 430). Upon determining that the second variance V2 is greater than the second variance threshold value VE2, the variance comparison unit 166 may assign the break flag to the m^{th} layer, and the process may go to step 220 (step 432). The first and second variance threshold values VE1 and VE2 may be the same as or different from each other. Further, each of the first and second variance threshold values VE1 and VE2 may be set in advance for each layer and stored, or may be set in advance to a constant value regardless of the layers.

However, when the first variance V1 is not greater than the first variance threshold value VE1 or when the second variance V2 is not greater than the second variance threshold value VE2, the possibility that the m^{th} layer is a moving object rather than a static object is higher, and thus the process goes to step 318. For example, the static object may be an object that does not move, such as a traffic light, a tree, a traffic sign, or a guardrail, and the moving object may be an object that is moving, such as a vehicle.

As described above, the variance comparison unit 166 compares the first variance V1 and the second variance V2 with the first variance threshold value VE1 and the second variance threshold value VE2, respectively, and assigns a break flag to the m^{th} layer in response to the result of the comparison.

Alternatively, step 316 may be omitted from the object shape analysis method 200 using a LiDAR sensor according to the embodiment.

Meanwhile, when the break flag is not assigned to the m^{th} layer, the flag assignment unit 156 may assign a shape flag to the m^{th} layer using at least one of the first line segment, the second line segment, the first LiDAR points, or the second LiDAR points (steps 318 and 320).

To this end, as shown in FIG. 3, the flag assignment unit 156 may include a temporary flag assignment unit 170 and a final flag assignment unit 180.

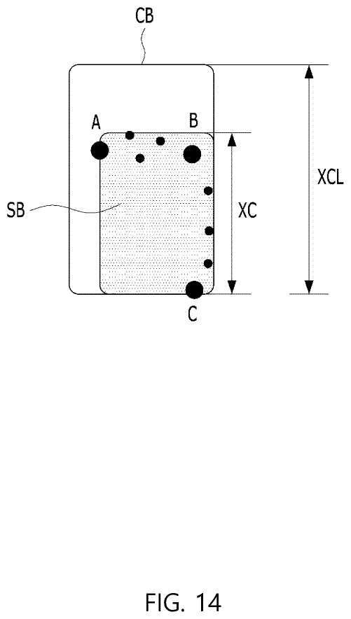

The temporary flag assignment unit 170 temporarily assigns an L-shaped flag or an I-shaped flag to the m^{th} layer as a shape flag in consideration of the size of the shape box of the m^{th} layer including the first and second line segments L1 and L2 in response to the result of the comparison by the variance comparison unit 166. The shape box will be described later in detail with reference to FIG. 14. That is, upon recognizing that the break flag has not been assigned to the m^{th} layer because the first variance V1 is not greater than the first variance threshold value VE1 and/or because the second variance V2 is not greater than the second variance threshold value VE2 as a result of the comparison by the variance comparison unit 166, the temporary flag assignment unit 170 may temporarily assign an L-shaped flag or an I-shaped flag to the m^{th} layer as a shape flag in consideration of the size of the shape box of the m^{th} layer including the first and second line segments (step 318).

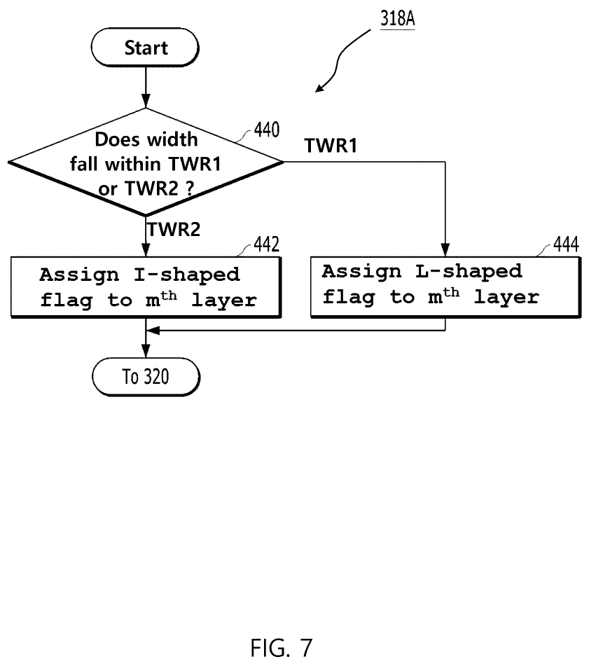

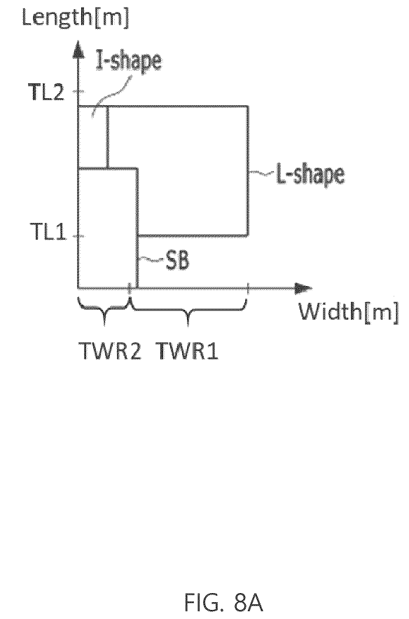

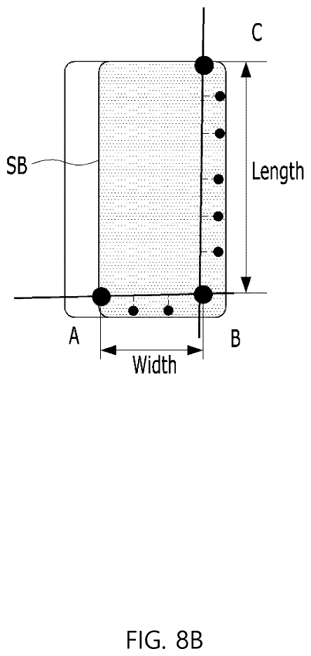

FIG. 7 is a flowchart of an embodiment 318A of step 318 shown in FIG. 4. FIGS. 8A and 8B are exemplary diagrams for helping understanding step 318A shown in FIG. 7.

For example, the temporary flag assignment unit 170 may temporarily assign an L-shaped flag or an I-shaped flag to the m^{th} layer using at least one of the length or the width of the shape box (e.g. SB shown in FIG. 8B) of the m^{th} layer.

That is, when it is recognized that the break flag has not been assigned to the m^{th} layer, whether the width of the shape box of the m^{th} layer falls within a first threshold width range TWR1 or a second threshold width range TWR2 may be determined (step 440).

If the width of the shape box of the m^{th} layer falls within the first threshold width range TWR1, the I-shaped flag is temporarily assigned to the m^{th} layer (step 442). However, if the width of the shape box falls within the second threshold width range, the L-shaped flag is temporarily assigned to the m^{th} layer (step 444).

When the first threshold width range TWR1 has a range of the first minimum value MIN1 to the first maximum value MAX1 and the second threshold width range TWR2 has a range of the second minimum value MIN2 to the second maximum value MAX2, the second minimum value MIN2 may be greater than or equal to the first maximum value MAX1. In this way, the shape flag may be assigned to the m^{th} layer using the width of the shape box SB, but the embodiment may not be limited thereto. That is, according to another embodiment, the shape flag may be temporarily assigned to the m^{th} layer using at least one of the width or the length of the shape box SB.

The device 100 according to the embodiment may track an object having a length of a predetermined value TL2 or less. When the length of the shape box SB shown in FIG. 8B falls within the range of TL1 to TL2, if the width of the shape box SB falls within the first threshold width range TWR1, the I-shaped flag may be temporarily assigned to the m^{th} layer, and if the width of the shape box SB falls within the second threshold width range TWR2, the L-shaped flag may be temporarily assigned to the m^{th} layer.

In order to perform the method shown in FIG. 7, as shown in FIG. 3, the temporary flag assignment unit 170 may include first and second width comparison units 172 and 174.

In conclusion, the temporary flag assignment unit 170 may temporarily assign the L-shaped flag or the I-shaped flag to the m^{th} layer using at least one of the length or the width of the shape box SB (step 318A).

The first width comparison unit 172 may compare the width of the shape box SB with the first threshold width range TWR1, and may temporarily assign the L-shaped flag to the m^{th} layer in response to the result of the comparison. If the length of the shape box SB may be equal to or smaller than a predetermined length, the sL-shape flag may be temporally assigned. To this end, after determining the L-shape flag for the shape of the corresponding layer due to the comparison result that the width of the shape box SB may be within the first threshold width range TWR1, the first width comparison unit 172 may compare the length of the shape box SB with the predetermined length to determine whether to assign temporally the L-shape or the sL-shape flag to the layer. The second width comparison unit 174, on the other hand, may compare the width of the shape box SB with the second threshold width range TWR2, and may temporarily assign the I-shaped flag to the m^{th} layer in response to the result of the comparison.

After step 318, the final flag assignment unit 180 may determine whether to finally assign the L-shaped flag, the sL-shaped flag or the I-shaped flag, which has been temporarily assigned to the m^{th} layer, using at least one of the first line segment L1, the second line segment L2, the first LiDAR points, or the second LiDAR points (step 320).

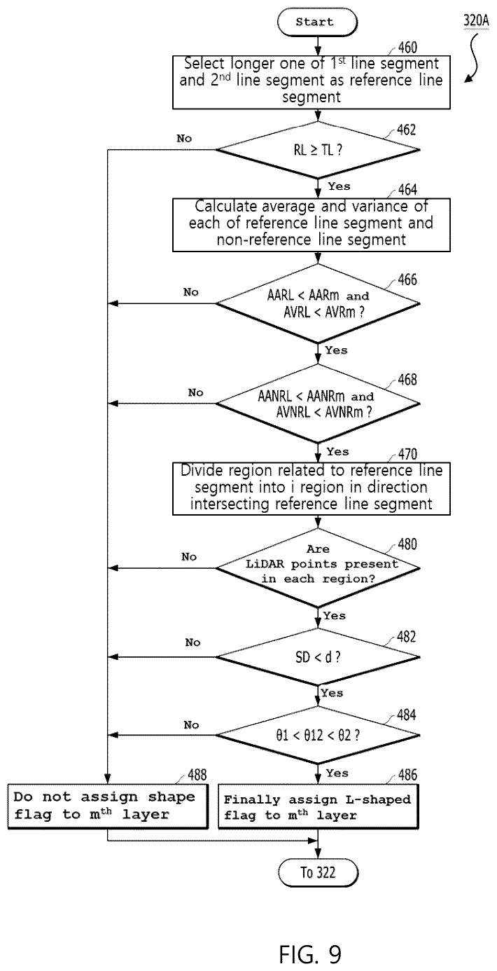

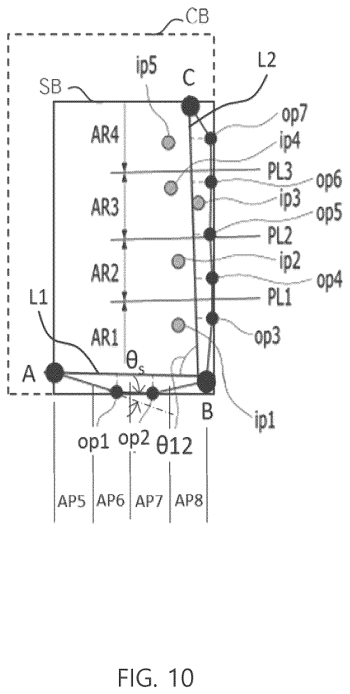

FIG. 9 is a flowchart of an embodiment 320A of step 320 shown in FIG. 4, and FIG. 10 is a diagram for helping understanding the embodiment 320A shown in FIG. 9. In FIG. 10, it may be assumed that the first and second line segments L1 and L2 correspond to the first and second line segments L1 and L2 obtained in step 314, respectively.

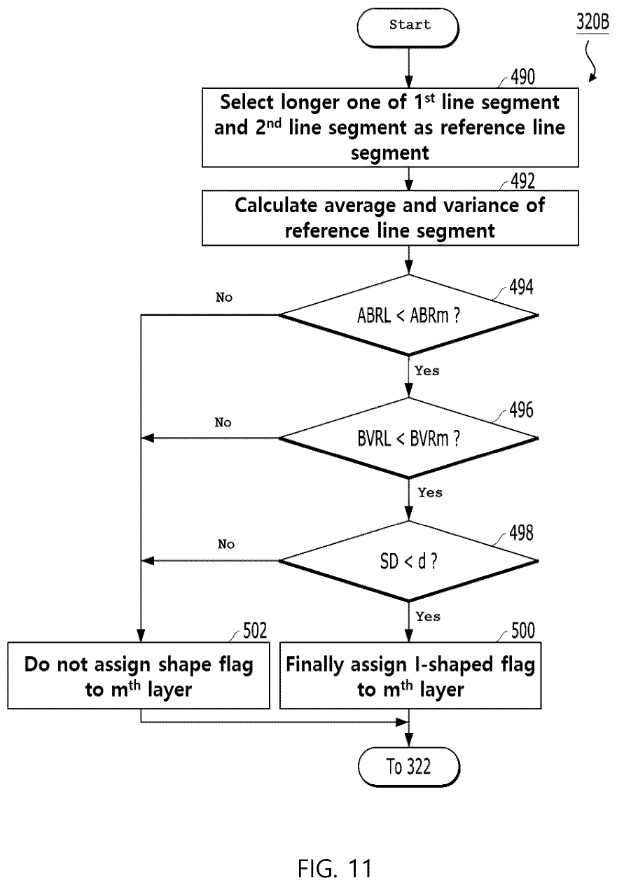

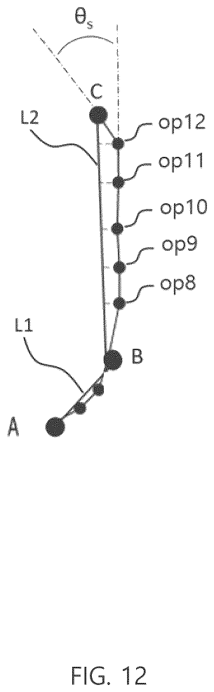

FIG. 11 is a flowchart of another embodiment 320B of step 320 shown in FIG. 4, and FIG. 12 is a diagram for helping understanding the embodiment 320B shown in FIG. 11.

FIGS. 10 and 12 represent an example of a case where the corresponding object may be located at the left upper side region (i.e., the second quadrant) from the host vehicle, and though the processes of FIGS. 9 and 11 are detailed below therewith, they can be applied to objects located at other side region. Also, though the L-shape flag may be assumed in FIGS. 9 and 11, the processes may be applied to the sL-shape flag too, and thus the details for the sL-shape flag may be omitted.

When the L-shaped flag was temporarily assigned to the m^{th} layer in step 318, the shape flag may be finally assigned to the m^{th} layer through the method 320A shown in FIG. 9 (step 320A). However, when the I-shaped flag was temporarily assigned to the m^{th} layer in step 318, the shape flag may be finally assigned to the m^{th} layer through the method 320B shown in FIG. 11 (step 320B).

In order to perform the embodiments 320A and 320B shown in FIGS. 9 and 11, the final flag assignment unit 180 may include, for example, a reference line segment selection unit 182, a first flag assignment analysis unit 184, and a second flag assignment analysis unit 186, as shown in FIG. 3.

Upon recognizing that the L-shaped flag has been assigned to the m^{th} layer based on the result of the comparison by the first width comparison unit 172, the first flag assignment analysis unit 184 may perform steps 462 to 488 shown in FIG. 9. However, step 462 shown in FIG. 9 may be performed by the reference line segment selection unit 182, rather than the first flag assignment analysis unit 184.

After step 318, the reference line segment selection unit 182 selects the longer line segment from among the first line segment L1 and the second line segment L2, provided from the determination preparation unit 152, as a reference line segment, and selects the shorter line segment from among the first line segment L1 and the second line segment L2 as a non-reference line segment (step 460). For example, referring to FIG. 10, since the second line segment L2 may be longer than the first line segment L1, the first line segment L1 may be selected as a non-reference line segment, and the second line segment L2 may be selected as a reference line segment.

After step 460, whether the length RL of the reference line segment (e.g. L2) may be greater than or equal to a threshold length TL is checked (step 462). Here, the threshold length may be set differently for each of the M layers, or may be set identically.

If the length RL of the reference line segment is not greater than or equal to the threshold length TL, the shape flag is not assigned to the m^{th} layer (step 488). However, when the length RL of the reference line segment is greater than or equal to the threshold length TL, the average and the variance of each of the reference line segment and the non-reference line segment are calculated (step 464).

Here, the average of the reference line segment means an average of the distances between the reference line segment and the LiDAR points located near the reference line segment, and the variance of the reference line segment means a variance of the distances between the reference line segment and the LiDAR points located near the reference line segment. The average of the non-reference line segment means an average of the distances between the non-reference line segment and the LiDAR points located near the non-reference line segment, and the variance of the non-reference line segment means a variance of the distances between the non-reference line segment and the LiDAR points located near the non-reference line segment.

After step 464, whether the average AARL and the variance AVRL of the reference line segment are less than a reference threshold average AARm and a reference threshold variance AVRm, respectively, is checked (step 466). Here, each of the reference threshold average AARm and the reference threshold variance AVRm may be set in advance for each set of coordinates of the m^{th} layer and stored, or may be set in advance to a constant value regardless of the coordinates of the m^{th} layer and stored.

If the average AARL of the reference line segment is not less than the reference threshold average AARm, or if the variance AVRL of the reference line segment is not less than the reference threshold variance AVRm, the shape flag is not assigned to the m^{th} layer (step 488).

However, if the average AARL of the reference line segment is less than the reference threshold average AARm and the variance AVRL of the reference line segment is less than the reference threshold variance AVRm, whether the average AANRL and variance AVNRL of the non-reference line segment are less than a non-reference threshold average AANRm and a non-reference threshold variance AVNRm, respectively, is checked (step 468). Here, each of the non-reference threshold average AANRm and the non-reference threshold variance AVNRm may be set in advance for each set of coordinates of the m^{th} layer and stored, or may be set in advance to a constant value regardless of the coordinates of the m^{th} layer and stored.

If the average AANRL of the non-reference line segment is not less than the non-reference threshold average AANRm, or if the variance AVNRL of the non-reference line segment is not less than the non-reference threshold variance AVNRm, the shape flag is not assigned to the m^{th} layer (step 488).

However, when the average AANRL of the non-reference line segment is less than the non-reference threshold average AANRm and the variance AVNRL of the non-reference line segment is less than the non-reference threshold variance AVNRm, the region related to the reference line segment is divided into i regions in the direction intersecting the reference line segment (step 470). Here, “i” is a positive integer of 1 or greater, preferably 3 or greater. For example, “i” may be 4. For example, referring to FIG. 10, it can be seen that the region related to the reference line segment L2 is divided into four (i=4) regions AR1 to AR4 in the direction intersecting the reference line segment L2. In order to divide the region, three (i−1=3) straight lines may be arranged so as to be oriented in the direction intersecting the reference line segment L2.

After step 470, whether a LiDAR point is present in each of the i regions resulting from the division is checked (step 480). In other words, whether a LiDAR point are present in each of the four divided regions AR1 to AR4 is checked (step 480). If no LiDAR point is present in even one of the four regions resulting from the division, the shape flag is not assigned to the m^{th} layer (step 488).

However, when the LiDAR point is present in each of the regions resulting from the division, whether the spacing distance SD between neighboring outer LiDAR points located in the regions resulting from the division is less than a threshold spacing distance d is checked (step 482). Here, the threshold spacing distance d may be set in advance. In FIG. 10, a line segment can be defined by connecting two neighboring outer LiDAR points with a straight line. For example, a line segment connecting the outer points op1 and op2, a line segment connecting the outer points op3 and op4, a line segment connecting the outer points op4 and op5, a line segment connecting the outer points op5 and op6, and a line segment connecting the outer points op6 and op7 may be defined, and in step 482, whether the length SDs of the segments is less than the threshold spacing distance d is determined. If the length SD of a segment is not less than the threshold spacing distance d, a shape flag is not assigned to the m^{th} layer (step 488).

To determine the outer points, for example, ‘Convex hull’ algorithm may be used. According to the ‘Convex hull’ algorithm, if a point in-between two neighboring points is located at the nearer side to the host vehicle with respect to the line segment connecting the two neighboring points, then the point is extracted as an outer point of the object, and vice versa.

If the length SDs of the segments are less than the threshold spacing distance d, whether the angle θ12 between the first line segment L1 and the second line segment L2 is greater than a first angle θ1 and less than a second angle θ2 is determined (step 484). Here, the first angle θ1 and the second angle θ2 may be set in advance for each layer, or may be set in advance to a constant value regardless of the layers. If the angle θ12 between the first line segment L1 and the second line segment L2 is less than the first angle θ1 or greater than the second angle θ2, the shape flag is not assigned to the m^{th} layer (step 488).

However, if the angle θ12 between the first line segment L1 and the second line segment L2 is greater than the first angle θ1 and less than the second angle θ2, the L-shaped flag is finally assigned to the m^{th} layer (step 486).

Upon recognizing that the I-shaped flag has been assigned to the m^{th} layer based on the result of the comparison by the second width comparison unit 174, the second flag assignment analysis unit 186 may perform steps 492 to 502 shown in FIG. 11.

First, referring to FIG. 11, the longer line segment among the first line segment L1 and the second line segment L2 is selected as the reference line segment (step 490). Since step 490 is the same as step 460, a description thereof will be omitted.

After step 490, whether the average ABRL and the variance BVRL of the reference line segment (L2 shown in FIG. 12) are less than a reference threshold average ABRm and a reference threshold variance BVRm, respectively, is determined (steps 494 and 496). Here, the reference threshold average ABRm and the reference threshold variance BVRm may be the same as the reference threshold average AARm and the reference threshold variance AVRm shown in FIG. 9, respectively, and may be set in advance for each of the M layers and stored, or may be set in advance to a constant value regardless of the layers and stored.

If the average ABRL is not less than the reference threshold average ABRm or if the variance BVRL is not less than the reference threshold variance BVRm, the shape flag is not assigned to the m^{th} layer (step 502). However, if the average ABRL is less than the reference threshold average ABRm and the variance BVRL is less than the reference threshold variance BVRm, whether the spacing distance SDs between the outer points located in j regions resulting from the division in the direction intersecting the reference line segment are less than the threshold spacing distance d is determined (step 498). Here, “j” is a positive integer of 1 or greater. “j” may be the same as or different from “i”. Since step 498 is the same as step 482, a duplicate description thereof will be omitted.

If the spacing distance SD is not less than the threshold spacing distance d, the shape flag is not assigned to the m^{th} layer (step 502). However, if the spacing distance SD is less than the threshold spacing distance d, the I-shaped flag is finally assigned to the m^{th} layer (step 500).

Meanwhile, referring again to FIG. 4, step 210A may further include step 322, which is performed after step 320. That is, the layer shape determination unit 142 shown in FIG. 3 may further include a roof layer inspection unit 158, which performs step 322. In some embodiments, step 322 and the roof layer inspection unit 158 may be omitted.

After the flag is finally assigned to the m^{th} layer, a confidence score (hereinafter, referred to merely as ‘score’) is calculated according the type of the flag (step 321).

To calculate the score, the layer shape determination unit 142 may further comprise a score calculation unit 187 comprising a first score calculation unit 188 and a second score calculation unit 189.

At first, in case of L-shape or sL-shape flag, with reference to FIG. 3, the first calculation unit 188 calculates a first score, and in case of I-shape flag, the calculation unit 189 calculates a second score.

The calculation of the first score is detailed with reference to FIG. 10 and the calculation of the second score with reference to FIG. 12.

In the present embodiment, the first score may be calculated by applying weights for five parameters, but not limited thereto.

For the convenience sake, the above mentioned parameters may be referred to as L-parameters.

A first L-parameter LPS1 relates to the distance variance of the outer points to the first line segment L1 and the second line segment L2, and may be obtained by calculating the variances to the first line segment L1 and the second line segment L2, respectively, and summing a first-line-segment score and a second-line-segment score accordingly obtained with reference to TABLE 1 below.

TABLE 1

| | First-line- | Second-line- |
|---|---|---|
| | segment Score | segment Score |
| Variance¹ < AV₁ | 50 | 50 |
| AV₁ ≤ variance < AV₂ | 20 | 20 |
| AV₂ ≤ variance | 0 | 0 |

With reference to TABLE 1, if the calculated variance may be below a first predetermined variance value AV1, then 50 may be assigned to the score, if the variance equal to or over the AV1 and below a second predetermined variance value AV2, then 20 assigned, and if the variance equal to or over the AV2, then 0 assigned. 1. variance to the first line segment L1 or the second line segment L2.

For example, assuming that the distance variance of the outer points op1 and op2 to the first line segment L1 may be below the first predetermined variance value AV1, and the distance variance of the outer points op3 to op7 to the second line segment L2 may be equal to or over the first predetermined variance value AV1 and below the second predetermined variance value AV2, 50 may be assigned to the first-line-segment score and 20 to the second-line-segment score, and thus the first L-parameter LPS1 may be determined to have a score of 70.

Next, the second L-parameter LPS2 relates to the locations of the outer points with respect to the first and second line segments, respectively, and may be determined according to the proportions of the points located at the nearer side to the host vehicle with respect to the first and second line segments, respectively.

In this embodiment, if the outer points associated to the first line segment L1 may be all located at the host vehicle side with respect to the first line segment L1 and the outer points associated to the second line segment L2 may be all located at the host vehicle side with respect to the second line segment L2, then 100 may be assigned to the score, and otherwise 0.

For example, because the outer points op1 and op2 may be located at the host vehicle side with respect to the first line segment L1, and the outer points op3 to op7 may be located at the host vehicle side with respect to the second line segment L2, the score of the second L-parameter becomes 100.

Next, the third L-parameter relates to the average angle of minimum relative angles between neighboring segments.

With respect to FIG. 10, the minimum relative angle between two neighboring segments may be defined as ‘180−the smaller angle between the segments,’ i.e. Θ s in FIG. 10 for the segment of points A and op1 and the segment of points op1 and op2, the smaller angle between two segments determined to be the smaller one among the two angles formed by two neighboring segments, and the third L-parameter LPS3 may be obtained by assigning and summing scores for the respective first and second line segments, each score determined according to TABLE 2 by the average angle of the associated segments, the segments associated to the first line segment L1 defined as the segments of A-op1, op1-op2, and op2-B, and the segments associated to the second line segment L2 as the ones of B-op3, op3-op4, op4-op5, op5-op6, op6-op7, and op7-C.

TABLE 2

| | First-line- | Second-line- |
|---|---|---|
| | segment Score | segment Score |
| average angle < Ang₁ | 50 | 50 |
| Ang₁ ≤ average angle < | 25 | 25 |
| Ang₂ | | |
| Ang₂ ≤ average angle | 0 | 0 |

With reference to TABLE 2, for the score for each line segment, if the average angle may be below a first predetermined angle Ang1, then 50 may be assigned, if the average angle equal to or over the first predetermined angle Ang1 and below a second predetermined angle Ang2, then 25 assigned, and if the average angle over the second predetermined angle Ang2, then 0 assigned.

For example, assuming that the average angle between segments for the first line segment L1 may be below the first predetermined angle Ang1 and the average angle between segments for the second line segment L2 may be equal to or over the first predetermined angle Ang1 and below the second predetermined angle Ang2, 50 may be assigned to the first line segment score and 20 to the second line segment score, and thus the third L-parameter LPS3 may be determined to have a score of 70.

Next, the fourth L-parameter LPS4 relates to a straight line reliability, in more detail to whether the outer points may be evenly distributed. This parameter may be determined according to the presence of an outer point in each inner side division area other than either outer side among the division areas which may be formed by dividing each of the line segments with 3 or more perpendicular lines.

In the present embodiment, for at least one of the first line segment L1 and the second line segment L2, if there exists at least one outer point in each inner side division area among the equally divided areas, then 100 may be assigned to the score, and otherwise 0 may be assigned.

For example, with reference to FIG. 10, because there exists an outer point in each of the inner side division areas AP6 and AP7 associated to the first line segment L1 and there, too, exists an outer point in each of the inner side division areas AP2 and AP3 associated to the second line segment L2, the score of the fourth L-parameter LPS4 becomes 100.

Next, the fifth L-parameter LPS5 relates to a proportion between the cluster box CB and the shape box SB.

If the size ratio of the shape box SB to the cluster box CB may be equal to or over a predetermined value, then 100 may be assigned to the score, and otherwise 0 assigned.

Preferably, the size ratio may be calculated by use of the longer side lengths of the two boxes.

The first score SC₁ may be calculated by the following Equation 5 with the above mentioned L-parameters.

SC₁=LPS1×w1+LPS2×w2+LPS3×w3+LPS4×w4+LPS5×w5 [Equation 5]

In Equation 5, w1, w2, w3, w4 and w5 may be weights for respective L-parameters.

Optimal values may be determined for the above weights through tests. Preferably, the fifth weight w5 may be greatest, the next greatest one may be the first weight w1 or the fourth weight w4, and the second weight w2 or the third weight w3 may be the next.

In the present embodiment, all of the five L-parameters may be used to calculate the first score, but not limited thereto. For example, only one of the five parameters may be used, and also any two or more may be used together. Preferably, as the parameters for the calculation of the first score, the fifth L-parameter LPS5 may be necessarily included, and more preferably, the first and the fourth L-parameters LPS1 and LPS4 may be included too, without limited thereto.

The calculation of the second score may be detailed with reference to FIG. 12.

In the present embodiment, the second score may be calculated by applying weights to two parameters, respectively, but not limited thereto.

For the convenience sake, the parameters may be referred to as I-parameters.

At first, a first I-parameter IPS1 relates to the distance variance of the outer points to the second line segment L2 (or the reference line segment, the same below), and its score may be determined with the variance to the second line segment L2 with reference to TABLE 3 below.

TABLE 3

| | IPS1 score |
|---|---|
| variance < AV₃ | 100 |
| AV₃ ≤ variance < AV₄ | 50 |
| AV₄ ≤ variance | 0 |

With reference to TABLE 3, if the calculated variance may be below a third predetermined variance value AV3, then 100 may be assigned to the score, if the variance equal to or over the third predetermined variance value AV3 and below a fourth predetermined variance value AV4, then 50 assigned, and if the variance equal to or over the fourth predetermined variance value AV4, then 0 assigned.

For example, in FIG. 12, assuming that the distance variance of the outer points op8 to op12 to the second line segment L2 may be below the third predetermined variance value AV3, the score for the first I-parameter IPS1 becomes 100.

Next, a second I-parameter IPS2 relates to the average of minimum relative angles between segments, likewise the third L-parameter LPS3. The second I-parameter IPS2, however, may be calculated only for the second line segment L2.

With reference to 12, the second I-parameter IPS2 may be determined through TABLE 4 below according to the average angle of the minimum relative angles between segments.

TABLE 4

| | IPS2 Score |
|---|---|
| average angle < Ang₃ | 100 |
| Ang₃ ≤ average angle < Ang₄ | 50 |
| Ang₄ ≤ average angle | 0 |

With reference to TABLE 4, for the score of the second I-parameter IPS2, if the average angle may be below a third predetermined angle Ang3, then 100 may be assigned, if the average angle equal to or over the third predetermined angle Ang3 and below a fourth predetermined angle Ang4, then 50 assigned, and if the average angle equal to or over the fourth predetermined angle Ang4, then 0 assigned.

For example, assuming that the average angle between segments associated to the second line segment L2, the second I-parameter IPS2 may be determined to have the score of 100.

The second score SC2 may be calculated by Equation 6 below by use of the above described I-parameters.

SC₂=IPS1×g1+IPS2×g2 [Equation 6]

In Equation 6, g1 and g2 may be weights for respective I-parameters.

Optimal values of the weights may be determined through test, too. Preferably, the first weight g1 may be greater than the second weight w2, but not limited thereto.

After step 321, the roof layer inspection unit 158 may check whether the m^{th} layer may be a layer related to the roof of the target object (hereinafter referred to as a “roof layer”), and may output the result of the checking to the first flag assignment analysis unit 184 and the determination preparation unit 152 (step 322). If the m^{th} layer may be the roof layer of the target object, the non-reference threshold average AANRm and the non-reference threshold variance AVNRm, which may be used for the m+1th layer in step 320, i.e. step 468 shown in FIG. 9, may be increased (step 324). In this way, when the non-reference threshold average AANRm and the non-reference threshold variance AVNRm may be increased, conditions to be considered in order to assign the L-shaped flag to the m+1^{th} layer may be relaxed. The purpose of this may be that, when the target object may be a vehicle, the structural characteristic of the target vehicle in which the front bumper may be rounder than the rear bumper may be reflected in the determination as to whether to assign the L-shaped flag to the m+1^{th} layer.

Step 324 may be performed by the first flag assignment analysis unit 184, the roof layer inspection unit 158, or the determination preparation unit 152.

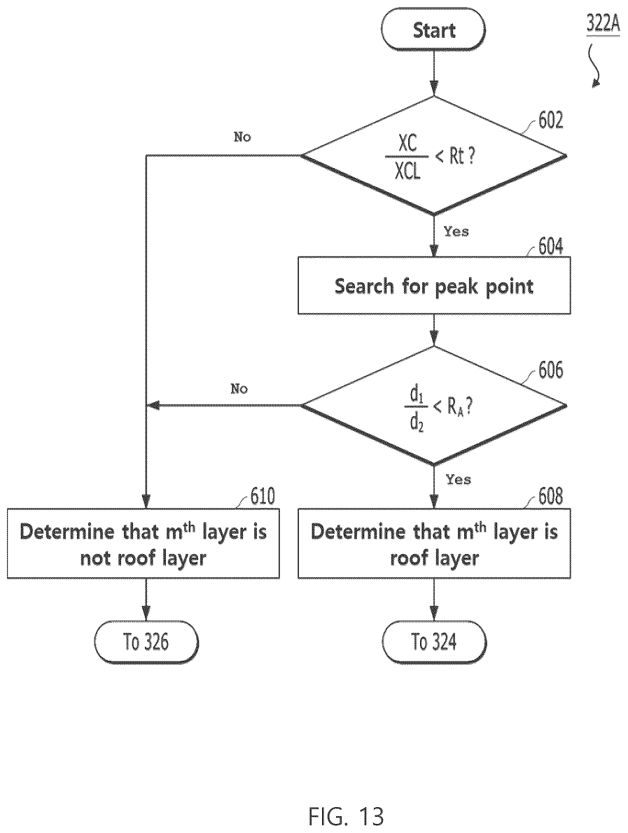

FIG. 13 is a flowchart of an embodiment 322A of step 322 shown in FIG. 4, and FIGS. 14 to 16 are diagrams for helping understanding step 322A shown in FIG. 13.

In FIG. 14, the clustering box CB may be a box including the LiDAR points related to the first to M^{th} layers, and the shape box SB may be a box including the LiDAR points related to the m^{th} layer.

According to the embodiment, the roof layer inspection unit 158 may perform steps 602 to 610 shown in FIG. 13.

First, referring to FIG. 14, whether the first ratio R1 of the length XC of the shape box SB of the m^{th} layer to the length XCL of the clustering box CB related to the target object may be less than a first threshold ratio Rt may be determined as in Equation 7 below (step 602).

$$\frac{XC}{XCL} < Rt \qquad [ Equation 7 ]$$

Here, “XC/XCL” represents the first ratio R1. The first threshold ratio Rt may be set in advance for each of the M layers, or may be set in advance to a constant value regardless of the M layers.

If the first ratio R1 may be less than the first threshold ratio Rt, a peak point may be searched for according to each shape flag finally assigned to the m^{th} layer (step 604). For example, the roof layer inspection unit 158 may determine a LiDAR point located farthest from the shorter one of the first line segment L1 and the second line segment L2 to be a peak point, or may determine the break point to be a peak point in response to the result of the comparison between the first ratio R1 and the first threshold ratio Rt and the result of the final assignment of the shape flag by the final flag assignment unit 184.

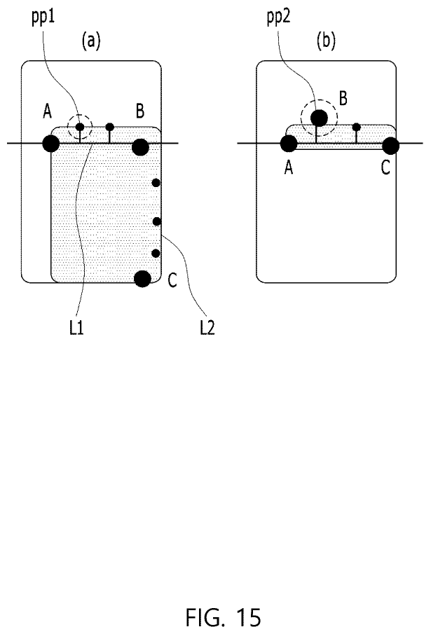

In detail, in the case in which the L-shaped flag may be finally assigned to the m^{th} layer, referring to FIG. 15(a), the LiDAR point pp1 located farthest from the shorter one (L1 in FIG. 15(a)) of the first line segment L1 and the second line segment L2 may be determined to be a peak point. Alternatively, in the case in which the I-shaped flag may be finally assigned to the m^{th} layer, as shown in FIG. 15(b), the break point (point located at region B) pp2 may be determined to be a peak point.

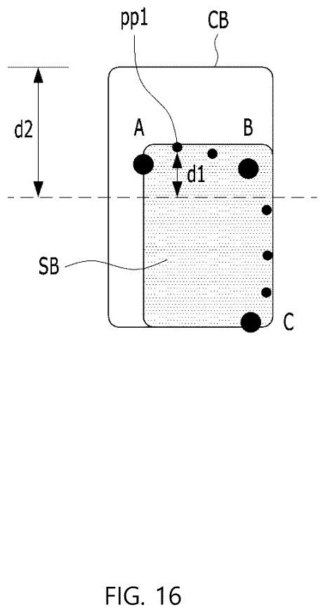

After step 604, whether the second ratio of the length from the peak point to the middle of the clustering box to half the length of the clustering box may be less than a second threshold ratio may be checked (step 606). For example, when the L-shaped flag may be finally assigned to the m^{th} layer and the peak point may be determined to be pp1 shown in FIG. 15(a), as shown in FIG. 16, whether the second ratio R2 of the length d1 from the peak point pp1 to the middle of the clustering box CB to half d2 the length of the clustering box CB may be less than the second threshold ratio RA may be checked as in Equation 8 below.

$$\frac{d 1}{d 2} < {R}_{A} \qquad [ Equation 8 ]$$

Here, “d1/d2” represents the second ratio R2. The second threshold ratio RA may be set in advance for each of the M layers, or may be set in advance to a constant value regardless of the M layers.

If the second ratio R2 is less than the second threshold ratio RA, it is determined that the m^{th} layer is the roof layer of the target object (step 608). However, if the first ratio R1 is not less than the first threshold ratio Rt or if the second ratio R2 is not less than the second threshold ratio RA, it is determined that the m^{th} layer is not the roof layer of the target object (step 610).

Referring again to FIG. 4, after it may be determined that the m^{th} layer may not be the roof layer of the target object, or after step 324, whether m is M is checked (step 326). If m is not M, m is increased by 1, and then the process goes to step 312 (step 328). Accordingly, steps 312 to 324 are performed on the m+1th layer. That is, the shape flag may be assigned to the m+1th layer in the same method as the method of assigning the shape flag to the m^{th} layer. For example, steps 326 and 328 may be performed by the determination preparation unit 152, but the embodiment is not limited thereto.

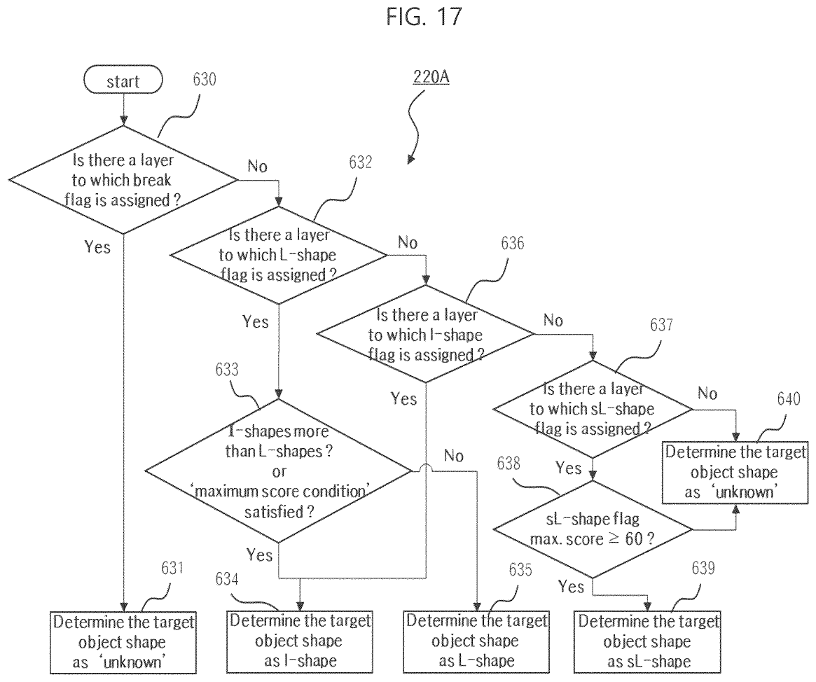

FIG. 17 is a flowchart of an embodiment 220A of step 220 shown in FIG. 2.

Performing step 220, i.e. the determination of the shape of a target object may be made with the process that the shape may be determined basically according to the priority order of the shapes, in which the L-shape comes first, the I-shape next, and the sL-shape last, and then modified according to the first scores or the second score.

Described in brief, though detailed below, the determination according to the priority order may comprise determining first whether there may be a layer of the L-shape flag among the layers for the detected object, and if not, determining whether there may be a layer of the I-shape flag, and if not L-shape nor I-shape, determining whether there may be a layer of the sL-shape flag.

In order to perform the embodiment 220A shown in FIG. 17, as shown in FIG. 3, the target shape determination unit 144 may include first to fourth flag inspection units 192, 194, 196 and 197, and a final shape output unit 198.

The first flag inspection unit 192 checks whether there may be a layer to which the break flag has been assigned, among the first to M^{th} layers, and outputs the result of the checking to the final shape output unit 198 (step 630). Upon determining that there may be a layer to which the break flag has been assigned, among the first to M^{th} layers, based on the result of the checking by the first flag inspection unit 192, the final shape output unit 198 determines that the shape of the target object may be ‘unknown’ (step 632).

The second flag inspection unit 194, in response to the result from the first inspection unit 192 that there may be no break-flag layer, checks whether there may be a layer to which the L-shape flag may be assigned (step 632), and outputs the check result to the third flag inspection unit 196 (No in step 632) or performs a subsequent check (step 633). In case where there may be at least one L-shape flag layer (step 632), whether the number of I-shape flag layers may be larger than that of L-shape flag layers (first condition) or the ‘maximum score condition’ (second condition) detailed below may be fulfilled may be subsequently checked (step 633), and the result may be output to the final shape output unit 198. The final shape output unit 198 determine I-shape as the target object shape if it may be determined according to the received result that at least one of the first and second conditions may be fulfilled (step 634), otherwise L-shape (step 635).

In the above description, the ‘maximum score condition’ may be defined that the maximum of the first scores of the L-shape flag layers may be below a first predetermined score and the maximum of the second scores of the I-shape flag layers may be equal to or over a second predetermined score. If there may be a L-shape flag layer, then the shape of the target object may be determined by the L-shape flag according to the priority order rule, however, nonetheless, if there may be a I-shape flag which may represent better the heading, in other words, the maximum score condition may be fulfilled, then more precise heading information may be obtained by determining the shape of the target object to be the I-shape flag.

Upon recognizing that there may be no layer to which the L-shaped flag has been assigned based on the result of the checking by the second flag inspection unit 194, the third flag inspection unit 196 checks whether there may be a layer to which the I-shaped flag has been assigned (step 636) and outputs the result of the checking to the final shape output unit 198. Upon recognizing that there may be no layer to which any one of the break flag and the L-shaped flag has been assigned but there may be a layer to which the I-shaped flag has been assigned, among the first to M^{th} layers, based on the results of the checking by the first to third flag inspection units 192, 194 and 196, the final shape output unit 198 determines that the target object has an “I” shape (step 634). The third flag inspection unit 196, on the other hand, if it is determined that there is no I-shape flag layer in step 636 (No in step 636), may output the result to the fourth flag inspection unit 197.

The fourth flag inspection unit 197, in response to the result from the third flag inspection unit 196, checks whether there is a layer to which a sL-shape flag is assigned (step 637), and outputs the check result to the final shape output unit 198. If there is no sL-shape flag layer according to the result checked by the fourth flag inspection unit 197, then the final shape output unit 198 determines the shape of the target object as ‘unknown’ (step 640). On the other hand, if it is determined that there is a sL-shape flag layer (Yes in step 637), then fourth flag inspection unit 197 subsequently checks whether the maximum score of the second scores of the sL-shape flag layers is equal to or over a third predetermined score (step 638), and outputs the result to the final shape output unit 198. The final shape output unit 198 may determine the shape of the target object as sL-shape if the maximum score is equal to or over the third predetermined score (step 639), and otherwise ‘unknown’ (step 640).

As described above, when the final shape output unit 198 determines the shape of the target object, the break flag, the L-shaped flag, the I-shaped flag, and the sL-shaped flag may be checked in that order.

On the other hand, upon recognizing that there may be no layer to which any one of the break flag, the L-shaped flag, and the I-shaped flag has been assigned, among the first to M^{th} layers, based on the results of the checking by the first to fourth flag inspection units 192, 194, 196 and 197, the final shape output unit 198 determines that the shape of the target object may be ‘unknown.’

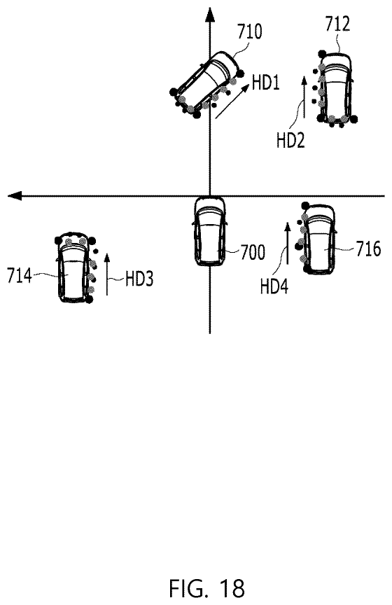

FIG. 18 shows various types of target vehicles 710 to 716 on the basis of the host vehicle 700.

Referring to FIG. 18, the target vehicle 716, only the side surface of which may be scanned from the host vehicle 700, has an I-shaped contour, and the target vehicles 710, 712 and 714, the side surfaces and the bumpers of which may be scanned from the host vehicle 700, have L-shaped (including sL-shaped) contours. A moving object in a downtown area or an expressway mainly has an L-shaped contour or an I-shaped contour. Therefore, it may be possible to temporarily determine in step 318 whether an object has an I-shaped contour or an L-shaped contour based on the size of the shape box SB having the form of a contour.

The contour of a target vehicle, which may be a target object, may be determined by the object-tracking device 100 and the object shape analysis method 200 using a LiDAR sensor according to the embodiments described above. For example, referring to FIG. 18, the target vehicles 710, 712 and 714 may be determined to have L-shaped contours, and the target vehicle 716 may be determined to have an I-shaped contour. In this case, the object-tracking device 100 according to the embodiment may recognize the heading directions of the target vehicles 710 to 716 using the determined contours of the target vehicles. For example, when the target vehicles 710 to 716 have L-shaped and I-shaped contours, the heading directions of the target vehicles 710 to 716 may be directions (e.g. HD1, HD2, HD3 and HD4 shown in FIG. 18) parallel to the longer one of the first line segment L1 and the second line segment L2.

To determine the heading of a detected object, it may be necessary to select a layer or flag (hereinafter, referred to as ‘heading layer’ or ‘heading flag’) for using for the determination among the corresponding layers.

In the present embodiment, the L-shape flag, of which the first score may be greatest among all the L-shape flags, may be determined to be the heading flag if L-shape flag may be determined as the shape of the target object, the I-shape flag, of which the second score may be greatest among all the I-shape flags, may be determined to be the heading flag if I-shape flag may be determined as the shape of the target object, and the sL-shape flag, of which the first score may be greatest among all the sL-shape flags, may be determined to be the heading flag if sL-shape flag may be determined as the shape of the target object. That is, the heading of the corresponding object may be determined according to the maximum score rule among the same shape flags as the one determined as the shape of the corresponding object.

A result of the embodiment of the present disclosure may be compared below with that of a comparative example method for determining the shape of a target object.

The comparative example method determines the shape of objects only according to the priority order rule without considering the first and second scores. Also, according to the comparative example method, the flag or layer which has the smallest of the mean and variance values of the distances of the associated outer points even only for any one of the first and second line segments L1 and L2 may be determined to be the heading flag or layer.

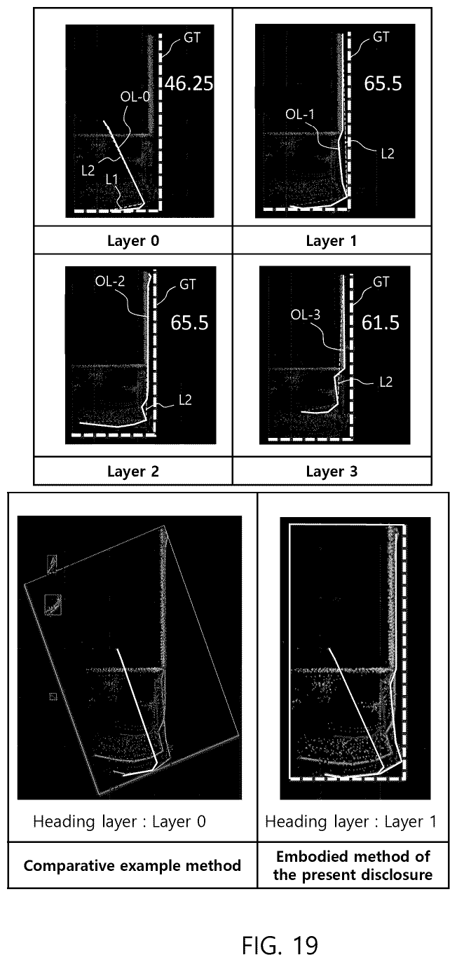

First, with reference to FIG. 19, layer 0 to 3 data of LiDAR points for a test object are shown.

It may be shown that the outer outline OL-0 formed by connecting the outer points of the LiDAR points on the layer 0 corresponds to the L-shape with the second line segment L2 oriented along the left-upper direction with largely angled with the ground truth, and the first score therefor may be 46.25.

And, it may be shown that the outer outline OL-1 formed by connecting the outer points of the LiDAR points on the layer 1 corresponds to the L-shape with the direction of the second line segment L2 well matched to the ground truth with a small angle, and the first score therefor may be 65.5.

It may be also shown that the outer outline OL-2 formed by connecting the outer points of the LiDAR points on the layer 2 corresponds to the L-shape with the direction of the second line segment L2 angled with the ground truth with a larger angle than in the case of the layer 1, and the first score therefor may be 65.5.

For the layer 3, it may be shown that the outer outline OL-3 formed by connecting the outer points of the LiDAR points thereon corresponds to the L-shape with the direction of the second line segment L2 angled with the ground truth with a larger angle than in the case of the layer 2, and the first score therefor may be 61.5.

According to the comparative example method, with respect to the distance variance of outer points to each line segment, because the distance variance of the associated outer points to the first line segment L1 in the layer 0 may be smallest among those in the layers, the layer 0 may be selected as the heading layer. However, according to the embodiment, because the heading layer for the cases of the L-shape and sL-shape may be determined by considering a comparison result of first scores thereof in addition to the result of the priority order rule, the layer 1 may be accordingly selected as the heading layer.

The comparative example method may be problematic in that the heading of the corresponding object may be wrongly determined to be directed toward the left-upper direction due to the determination of the heading layer of the layer 0, however, the problem may be solved in the embodiment by use of the scores.

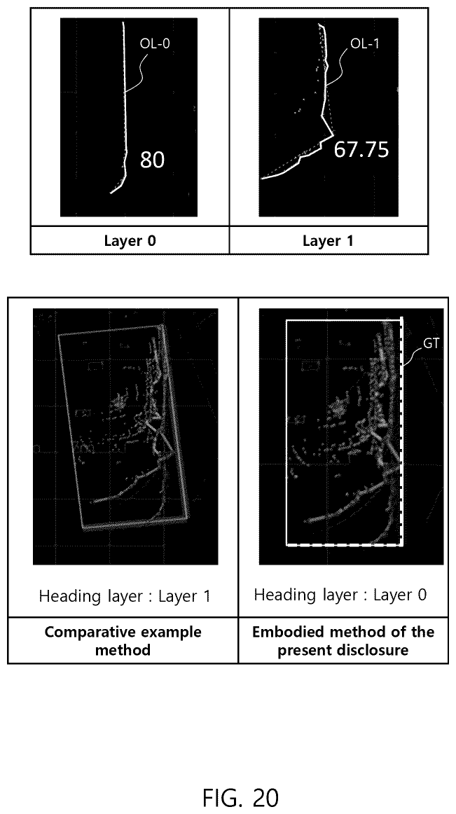

For another comparison result, with reference to FIG. 20, the I-shape may be determined for the layer 0, and the L-shape for the layer 1, with the second score for the layer 0 being 80 and the first score for the layer 1 being 67.75.

In this case, according to the comparative example method, the shape of the corresponding object may be determined to be the L-shape according to the priority order rule because there exist a L-shape flag, and the layer 1 may be selected as the heading layer. However, according to the embodiment of the present disclosure, because though the L-shape flag may be determined to be in exist in the above described step 632, the maximum score condition may be satisfied in step 633, the layer 0, which may be closer to the ground truth, may be selected as the heading layer.

On the other hand, the present disclosure described above may be embodied as computer-readable code on a medium in which a program may be recorded. The computer-readable medium includes all types of recording devices in which data readable by a computer system may be stored. Examples of the computer-readable medium include a hard disk drive (HDD), a solid-state drive (SSD), a silicon disk drive (SDD), a ROM, a RAM, a CD-ROM, a magnetic tape, a floppy disk, an optical data storage device, etc. Therefore, the above detailed description should not be construed as restrictive and should be considered as illustrative in all respects. The scope of the present disclosure should be determined by a reasonable interpretation of the appended claims, and all modifications within the equivalent scope of the present disclosure may be included in the scope of the present disclosure.

The foregoing descriptions of specific exemplary embodiments of the present disclosure have been presented for purposes of illustration and description. They may not be intended to be exhaustive or to limit the present disclosure to the precise forms disclosed, and obviously many modifications and variations may be possible in light of the above teachings. The exemplary embodiments were chosen and described to explain certain principles of the present disclosure and their practical application, to enable others skilled in the art to make and utilize various exemplary embodiments of the present disclosure, as well as various alternatives and modifications thereof. It may be intended that the scope of the present disclosure be defined by the Claims appended hereto and their equivalents.

What is claimed is:

1. A method for analyzing a shape of an object by use of LiDAR, the method comprising:
obtaining a plurality of layers of LiDAR points for the object by use of the LiDAR;
determining a shape flag for each layer of the plurality of layers by use of at least a part of LiDAR points thereon according to a plurality of predetermined shape types;
calculating a confidence score for the shape flag determined for each layer of the plurality of layers by use of the at least part of LiDAR points; and
determining a shape flag of the object by use of the shape flags determined for the plurality of layers and the confidence scores.

2. The method of claim 1, wherein the confidence score is calculated differently according to the predetermined shape type which the determined shape flag belongs to.

3. The method of claim 2, wherein the at least part of LiDAR points includes outer points which include a first end point, a second end point, and a break point,
and wherein the confidence score is calculated by use of the outer points.

4. The method of claim 3, wherein the plurality of predetermined shape types include a L-shape and a I-shape,
and wherein the shape flag for each layer of the plurality of layers is determined by a length and/or a width of a smallest rectangular shape box encompassing the outer points,
and wherein the confidence score includes a first score for the L-shape and a second score for the I-shape, the second score calculated differently from the first score.

5. The method of claim 4, wherein the first score is calculated by at least one of:
a first L-parameter which is calculated from distance variances of the associated outer points to a first line segment and a second line segment, respectively, the first line segment formed by connecting the first end point and the break point and the second line segment formed by connecting the break point and the second end point;
a second L-parameter which is calculated according to whether the associated outer points are located at a host-vehicle side with respect to the first and second line segments, respectively;
a third L-parameter which is calculated from angles between two neighboring segments, each segment formed by connecting two neighboring points of the outer points;
a fourth L-parameter which is calculated according to whether there exists at least one of the outer points in each inner side division area other than either outer side among division areas which are formed by dividing each of the line segments with 3 or more perpendicular lines; and
a fifth L-parameter which is calculated according to a proportion of at least one of length, width, and area between the shape box and a cluster box which is defined by the whole LiDAR points of the object.

6. The method of claim 5, wherein the first score is calculated by summing the L-parameters multiplied by weights, respectively.

7. The method of claim 6, wherein a first weight for the fifth L-parameter is greatest, a second weight for the first or fourth L-parameter next greatest, and a third weight for the second or third L-parameter is smallest.

8. The method of claim 4, wherein the second score is calculated by at least one of:
a first I-parameter which is calculated from a distance variance of the associated outer points to a longer one of a first line segment and a second line segment, the first line segment formed by connecting the first end point and the break point and the second line segment formed by connecting the break point and the second end point; and
a second I-parameter which is calculated from angles between two neighboring segments associated to the second line segment, each segment formed by connecting tow neighboring points of the outer points.

9. The method of claim 8, wherein the second score is calculated by summing the I-parameters multiplied by weights, respectively.

10. The method of claim 9, wherein a first weight for the first I-parameter is greater than a second weight for the second I-parameter.

11. The method of claim 1, wherein the determination of the shape flag of the object is according to a predetermined priority order for the plurality of predetermined shape types, and is finally made with the confidence scores taken into consideration.

12. The method of claim 11, wherein the plurality of predetermined shape types include a L-shape and a I-shape,
and wherein the L-shape is prior to the I-shape according to the predetermined priority order.

13. The method of claim 12, wherein, in case where at least one L-shape flag is included in the plurality of layers, if at least one of a first condition of whether a number of I-shape flags are greater that a number of L-shape flags for the plurality of layers and a second condition that a greatest score of the confidence scores among L-shape flag scores is below a first predetermined score and a greatest score of the confidence scores among I-shape flag scores is equal to or over a second predetermined score is satisfied, then the shape flag of the object is determined as the I-shape.

14. The method of claim 12, wherein if there is no L-shape flag in the plurality of layers and at least one I-shape flag is included, then the shape flag of the object is determined as the I-shape.

15. The method of claim 12, wherein the plurality of predetermined shape types further include a sL-shape,
and wherein the I-shape is prior to the sL-shape according to the predetermined priority order.

16. The method of claim 15, wherein, in case where there exists neither I-shape nor L-shape in the plurality of layers and at least one sL-shape flag is included, if a greatest score among sL-shape flag scores is equal to or over a third predetermined score, then the shape flag of the object is determined as the sL-shape.

17. The method claim 1, wherein a heading of the object is determined by use of the LiDAR points on a layer whose shape flag is determined as the shape flag of the object.

18. An object tracking device comprising:
LiDAR configured to obtain first to M^{th} (M is an integer of 2 or greater) layers of LiDAR points for objects including a target object;
a clustering unit configured to group neighboring and similar points of the LiDAR points into clusters; and
a shape analysis unit configured to analyze a shape of the target object based on a clustered LiDAR points,
wherein the shape analysis unit comprises:
a layer shape determination unit configured to determine a shape flag for each of the first to M^{th} layers by use of at least a part of LiDAR points thereon according to a plurality of predetermined shape types, and calculate a confidence score for the shape flag determined for each layer by use of the at least part of LiDAR points; and
a target shape determination unit configured to determine a shape flag of the object by use of the shape flags determined for the layers and the confidence scores.

19. A vehicle comprising the object tracking device of claim 18.
